(19) United States
(12) Patent Application Publication
(10) Pub. No.: US 2025/0299851 A1
(43) Pub. Date: Sep. 25, 2025

(54) Production System and Method For Electrical Connection Product

(71) Applicants: TE Connectivity Solutions GmbH, Schaffhausen (CH); Tyco Electronics (Shanghai) Co., Ltd., Shanghai (CN)

(72) Inventors: An (Joshua) Yang, Shanghai (CN); Lvhai (Samuel) Hu, Shanghai (CN); Roberto Francisco-Yi Lu, Bellevue, WA (US)

(73) Assignees: TE Connectivity Solutions GmbH, Schaffhausen (CH); Tyco Electronics (Shanghai) Co., Ltd., Shanghai (CN)

(21) Appl. No.: 19/085,398

(22) Filed: Mar. 20, 2025

(30) Foreign Application Priority Data
Mar. 22, 2024 (CN) 202410339529.X

(51) Int. Cl. H01B 13/012

(52) U.S. Cl. CPC H01B 13/01209

(57) ABSTRACT

A production system for producing electrical connection products includes a first assembly device and a second assembly device. The first assembly device assembles a first connector onto a first wire harness end of a wire harness product. The second assembly device assembles a second connector onto a second wire harness end of the wire harness product. The first assembly device and the second assembly device are arranged side by side and face each other. The first assembly device and the second assembly device simultaneously assemble the first connector and the second connector.

### CROSS-REFERENCE TO RELATED APPLICATION

This application claims the benefit of the filing date under 35 U.S.C. § 119 (a)-(d) of Chinese Patent Application No. CN202410339529.X filed on Mar. 22, 2024.

### FIELD OF THE INVENTION

The present invention relates to a production system and, more particularly, to a production system for producing an electrical connection product and a method for producing the electrical connection product.

### BACKGROUND OF THE INVENTION

In the prior art, some electrical connection products include wire harness products, and first connectors and second connectors assembled separately on two ends of a wire harness of the wire harness product. In order to assemble the first connector and the second connector onto the two ends of the wire harness product, it is usually necessary to provide a first assembly device for assembling the first connector and a second assembly device for assembling the second connector. The first assembly device and the second assembly device are arranged in series. This leads to excessively long assembly time and reduces assembly efficiency.

### SUMMARY OF THE INVENTION

A production system for producing electrical connection products includes a first assembly device and a second assembly device. The first assembly device assembles a first connector onto a first wire harness end of a wire harness product. The second assembly device assembles a second connector onto a second wire harness end of the wire harness product. The first assembly device and the second assembly device are arranged side by side and face each other. The first assembly device and the second assembly device simultaneously assemble the first connector and the second connector.

### BRIEF DESCRIPTION OF DRAWINGS

The invention will now be described by way of example with reference to the accompanying figures, of which:

FIG. 1 is a schematic view of a production system according to an exemplary embodiment;

FIG. 2 is a schematic view of a production system according to another exemplary embodiment; and

FIG. 3 is a schematic view of a production system according to another exemplary embodiment.

### DETAILED DESCRIPTION

Exemplary embodiments of the present disclosure will be described hereinafter in detail with reference to the attached drawings, wherein like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

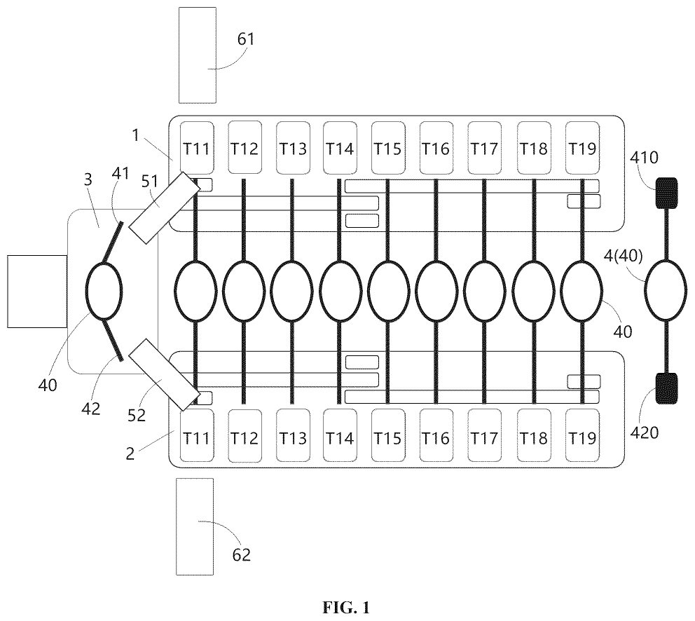

An exemplary embodiment of a production system is now described with reference to FIG. 1. This production system is used to produce electrical connection products 4. The electrical connection product 4 includes a wire harness product 40, a first connector 410 assembled to the first wire harness end 41 of the wire harness product 40, and a second connector 420 assembled to the second wire harness end 42 of the wire harness product 40.

As shown in FIG. 1, the production system includes a first assembly device 1 and a second assembly device 2. The first assembly device 1 is used to assemble the first connector 410 onto the first wire harness end 41 of the wire harness product 40. The second assembly device 2 is used to assemble the second connector 420 onto the second wire harness end 42 of the wire harness product 40. The first assembly device 1 and the second assembly device 2 are arranged side by side and face each other. The first assembly device 1 and the second assembly device 2 are used to simultaneously assemble the first connector 410 and the second connector 420 on the first wire harness end 41 and the second wire harness end 42, respectively.

As shown in FIG. 1, the production system further includes a wire harness product supply device 3, which is set upstream of the first assembly device 1 and the second assembly device 2, for supplying wire harness products 40 to the first assembly device 1 and the second assembly device 2.

As shown in FIG. 1, the production system further includes a first loading device 51, which is set at the upstream end of the first assembly device 1, for loading the first wire harness end 41 of the supplied wire harness product 40 onto the first assembly device 1.

As shown in FIG. 1, the production system further includes a second loading device 52, which is set at the upstream end of the second assembly device 2 for loading the second wire harness end 42 of the supplied wire harness product 40 onto the second assembly device 2.

As shown in FIG. 1, the first loading device 51 and the second loading device 52 are used to simultaneously load the first wire harness end 41 and the second wire harness end 42 onto the first assembly device 1 and the second assembly device 2, respectively.

As shown in FIG. 1, the production system further includes a first connector supply device 61, which is set on one side of the upstream end of the first assembly device 1 for supplying the first connector 410 to the first assembly device 1.

As shown in FIG. 1, the production system further includes a second connector supply device 62, which is provided on one side of the upstream end of the second assembly device 2 for supplying the second connector 420 to the second assembly device 2.

As shown in FIG. 1, the first connector supply device 61 and the second connector supply device 62 are used to simultaneously supply the first connector 410 and the second connector 420 to the first assembly device 1 and the second assembly device 2, respectively.

The production system further includes a quality inspection device, which is set downstream of the first assembly device 1 and the second assembly device 2 to detect whether the quality of the produced electrical connection product 4 is qualified.

The production system further comprises a qualified product recycling box, an unqualified product recycling box, and a sorting device. The qualified product recycling box is used to recycle electrical connection products 4 with qualified quality. The unqualified product recycling box is used to recycle electrical connection products 4 with unqualified quality. The sorting device places the qualified electrical connection products 4 into the qualified product recycling box and the unqualified electrical connection products 4 into the unqualified product recycling box based on the detection results of the quality inspection device.

As shown in FIG. 1, the first connector 410 and the second connector 420 are identical to each other and can be used interchangeably. As described herein, the same connectors refer to connectors with the same type and model. The first assembly device 1 and the second assembly device 2 are interchangeable and identical assembly devices.

As shown in FIG. 1, the first assembly device 1 and the second assembly device 2 have multiple assembly tools T11-T19 set up at different workstations for performing various assembly operations.

An exemplary embodiment of a method for producing an electrical connection product is now described with reference to FIG. 1. The method includes a step S10: Provide the aforementioned production system. The method further includes a step S20: The wire harness product supply device 3 supplies wire harness products 40 to the upstream ends of the first assembly device 1 and the second assembly device 2. The method further includes a step S30: The first loading device 51 and the second loading device 52 simultaneously load the first wire harness end 41 and the second wire harness end 42 of the wire harness product 40 onto the first assembly device 1 and the second assembly device 2, respectively. The method further includes a step S40: The first assembly device 1 and the second assembly device 2 simultaneously assemble the first connector 410 and the second connector 420 to the first wire harness end 41 and the second wire harness end 42 of the wiring harness product 40, respectively.

In step S40, the first connector supply device 61 and the second connector supply device 62 simultaneously supply the first connector 410 and the second connector 420 to the first assembly device 1 and the second assembly device 2, respectively.

The method further includes a step S50: Using a quality inspection device to check whether the quality of the produced electrical connection product 4 is qualified. The method further includes a step S60: Using a sorting device to place qualified electrical connection products 4 into qualified product recycling box and unqualified electrical connection products 4 into unqualified product recycling box, respectively.

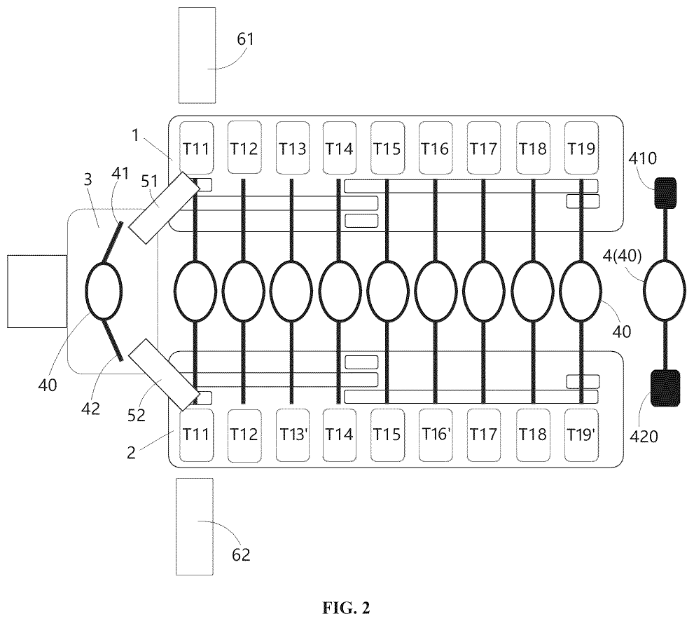

Another exemplary embodiment of a production system is now described with reference to FIG. 2. The main difference between the production system shown in FIG. 2 and the production system shown in FIG. 1 is that the assembly tools of the first assembly device 1 and the second assembly device 2 are different.

As shown in FIG. 2, the first connector 410 and the second connector 420 are connectors of the same type with different models. The first assembly device 1 and the second assembly device 2 are completely identical except for the assembly tools. The first assembly device 1 or the second assembly device 2 can assemble connectors of the same type with different models by replacing the assembly tools. For example, different models of the same type of connectors can be assembled by replacing the assembly tools T13, T16, and T19 on the second assembly device 2 shown in FIG. 1 with the assembly tools T13′, T16′, and T19′ shown in FIG. 2.

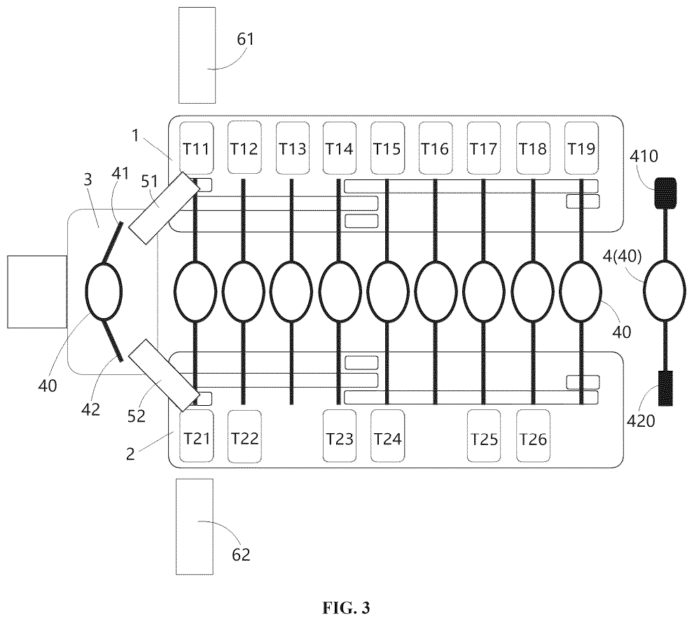

Another exemplary embodiment of a production system is now described with reference to FIG. 3. The main difference between the production system shown in FIG. 3 and the production system shown in FIG. 1 is the difference in the second assembly device 2.

As shown in FIG. 3, the first connector 410 and the second connector 420 are two different types of connectors with different models. The first assembly device 1 and the second assembly device 2 are two different assembly devices. The first assembly device 1 is suitable for assembling one type of connector with the multiple assembly tools T11-T19, while the second assembly device 2 is suitable for assembling another type of connector with multiple assembly tools T21-T26.

In the aforementioned exemplary embodiments according to the present invention, the first assembly device 1 and the second assembly device 2 are arranged side by side and face each other and can simultaneously assemble the first connector 410 and the second connector 420 on the first wire harness end 41 and the second wire harness end 42 of the wire harness product 40. Therefore, the present invention can improve assembly efficiency.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A production system for producing electrical connection products, comprising:
a first assembly device assembling a first connector onto a first wire harness end of a wire harness product; and
a second assembly device assembling a second connector onto a second wire harness end of the wire harness product, the first assembly device and the second assembly device arranged side by side and facing each other simultaneously assemble the first connector and the second connector.

2. The production system of claim 1, further comprising a wire harness product supply device installed upstream of the first assembly device and the second assembly device, the wire harness product supply device supplying the wire harness product to the first assembly device and the second assembly device.

3. The production system of claim 2, further comprising a first loading device at an upstream end of the first assembly device, the first loading device loads the first wire harness end onto the first assembly device.

4. The production system of claim 3, further comprising a second loading device at the upstream end of the second assembly device, the second loading device loads the second wire harness end onto the second assembly device.

5. The production system of claim 4, wherein the first loading device loads the first wire harness end onto the first assembly device at the same time that the second loading device loads the second wire harness end onto the second assembly device.

6. The production system of claim 1, further comprising a first connector supply device on one side of an upstream end of the first assembly device, the first connector supply device supplies a plurality of first connectors to the first assembly device.

7. The production system of claim 6, further comprising a second connector supply device on one side of the upstream end of the second assembly device, the second connector supply device supplies a plurality of second connectors to the second assembly device.

8. The production system of claim 7, wherein the first connector supply device supplies the first connector to the first assembly device at the same time that the second connector supply device supplies the second connector to the second assembly device.

9. The production system of claim 1, further comprising a quality inspection device installed downstream of the first assembly device and the second assembly device, the quality inspection device detects whether a quality of the electrical connection products are qualified.

10. The production system of claim 9, further comprising a qualified product recycling box for recycling qualified electrical connection products.

11. The production system of claim 9, further comprising an unqualified product recycling box for recycling unqualified electrical connection products.

12. The production system of claim 9, further comprising a sorting device placing qualified electrical connection products into a qualified product recycling box and unqualified electrical connection products into an unqualified product recycling box based on detection results of the quality inspection device.

13. The production system of claim 1, wherein the first connector and the second connector are identical to each other, and the first assembly device and the second assembly device are identical to each other.

14. The production system of claim 1, wherein the first connector and the second connector are different models of the same connector, the first assembly device and the second assembly device are identical aside from an assembly tool, and assembly tools of the first assembly device or the second assembly are replaceable.

15. The production system of claim 1, wherein the first connector and the second connector are two different types of different model connectors, the first assembly device and the second assembly device are two different assembly devices, the first assembly device assembling one type of connector, and the second assembly device assembling another type of connector.

16. A method for producing an electrical connection product, comprising:
providing a wire harness product;
loading a first end of the wire harness product and a second end of the wire harness product simultaneously; and
assembling a first connector on a first wire harness end and a second connector on a second wire harness end simultaneously.

17. The method of claim 16, wherein in the assembling step, a first connector supply device and a second connector supply device simultaneously supply the first connector and the second connector to a first assembly device and a second assembly device, respectively.

18. The method of claim 16, further comprising checking whether a quality of the electrical connection product is qualified after the assembling step.

19. The method of claim 16, further comprising sorting qualified electrical connection products into a qualified product recycling box and unqualified electrical connection products into an unqualified product recycling box after the assembling step.
